(19) United States
(12) Patent Application Publication
(10) Pub. No.: US 2025/0233477 A1
(43) Pub. Date: Jul. 17, 2025

(54) ELECTRIC DRIVE DEVICE

(71) Applicant: HONDA MOTOR CO., LTD., Tokyo (JP)

(72) Inventor: Hidenori IZAKI, Saitama (JP)

(21) Appl. No.: 18/974,149

(22) Filed: Dec. 9, 2024

(30) Foreign Application Priority Data
Jan. 17, 2024 (JP) 2024-005630

(51) Int. Cl. H02K 5/20; B64C 27/32; B64D 27/31; H02K 7/00; H02K 11/30

(52) U.S. Cl. CPC H02K 5/20; H02K 7/003; H02K 11/30; B64C 27/32; B64D 27/31

(57) ABSTRACT

An electric drive device includes a rotary electric machine and a controller. The rotary electric machine includes a hollow shaft extending in a prescribed axial direction, and a housing extending in the axial direction on an outer circumference of the shaft, the shaft includes a main body accommodated in the housing, and an extending portion extending from the main body toward the controller, the extending portion is provided with at least one shaft hole, the controller includes a casing extending in the axial direction on an outer circumference of the extending portion, and the casing is provided with at least one vent, and a cooling air passage extending in the axial direction is formed on an outer circumference of the casing, and the cooling air passage is connected to an internal space of the shaft via the shaft hole, an internal space of the casing, and the vent.

### TECHNICAL FIELD

The present invention relates to an electric drive device.

### BACKGROUND ART

In recent years, efforts to realize a low-carbon or carbon-free society have been gaining momentum, and research and development of electrification technologies is being conducted for vehicles, aircrafts, and the like to reduce CO₂ emissions and improve energy efficiency.

For example, WO 2023/057718 A1 discloses an electric drive device (integrated control motor) in which mechanical components are integrated with electrical components. This electric drive device includes a rotary electric machine (electric machine) including a shaft, and a controller (electronic control unit) that controls the rotary electric machine. As shown in FIG. 5 of WO 2023/057718 A1, centrifugal blades (a plurality of rotating blades) are attached to the shaft between the rotary electric machine and the controller. As these centrifugal blades rotate, a pressure difference is generated between the internal space of the rotary electric machine and the internal space of the controller, which generates an air flow from the internal space of the controller to the internal space of the rotary electric machine.

In WO 2023/057718 A1, the air introduced through the outer circumferential portion of the controller passes through the inner circumferential portion of the controller, and flows into the internal space of the rotary electric machine (see the arrow in FIG. 9 of WO 2023/57718 A1). Accordingly, the air heated by heat exchange with the outer circumferential portion of the controller passes through the inner circumferential portion of the controller. Such an air flow cannot sufficiently cool the inner circumferential portion of the controller where the heat is prone to be trapped, and the temperature imbalance within the controller may be deteriorated.

### SUMMARY OF THE INVENTION

In view of the above background, an object of the present invention is to suppress the temperature imbalance within the controller by sufficiently cooling the inner circumferential portion of the controller. Further, an object thereof is to contribute to the improvement of energy efficiency.

To achieve such an object, one aspect of the present invention provides an electric drive device (16) comprising: a rotary electric machine (31); and a controller (32) integrated with the rotary electric machine and configured to control driving of the rotary electric machine, wherein the rotary electric machine includes: a hollow shaft (38) extending in a prescribed axial direction; and a housing (36) extending in the axial direction on an outer circumference of the shaft, the shaft includes: a main body (55) accommodated in the housing; and an extending portion (56) extending from the main body toward the controller, the extending portion is provided with at least one shaft hole (59) that penetrates from an inner circumferential surface of the extending portion to an outer circumferential surface thereof, the controller includes a casing (74) extending in the axial direction on an outer circumference of the extending portion, and the casing is provided with at least one vent (103) that penetrates from an inner circumferential surface of the casing to an outer circumferential surface thereof, and a cooling air passage (229) extending in the axial direction is formed on an outer circumference of the casing such that the vent faces the cooling air passage, and the cooling air passage is connected to an internal space of the shaft via the shaft hole, an internal space of the casing, and the vent.

According to this aspect, when negative pressure is generated at the vent by the cooling air passing through the cooling air passage, this negative pressure causes the air in the internal space of the shaft to be drawn into the cooling air passage through the shaft hole, the internal space of the casing, and the vent. Accordingly, the air in the internal space of the shaft passes through the inner circumferential portion and the outer circumferential portion of the internal space of the casing and flows into the cooling air passage. Accordingly, the inner circumferential portion and the outer circumferential portion of the controller can be effectively cooled. In particular, the air in the internal space of the shaft is first introduced into the inner circumferential portion of the internal space of the casing. Accordingly, the inner circumferential portion of the controller where the heat is prone to be trapped can be sufficiently cooled, and the temperature imbalance within the controller can be suppressed.

In the above aspect, preferably, the electric drive device further comprises a fan (33) configured to rotate integrally with the shaft and thereby introduce cooling air into the cooling air passage.

According to this aspect, the fan can forcibly introduce a large amount of cooling air into the cooling air passage. Accordingly, the negative pressure generated at the vent increases, and this negative pressure can increase the flow rate of the air taken into the cooling air passage from the internal space of the casing through the vent. Accordingly, the cooling effect on the controller can be enhanced.

In the above aspect, preferably, the shaft further includes a protruding portion (57) protruding from the main body toward a side opposite to the controller, and the fan is arranged on the side opposite to the controller with the rotary electric machine interposed therebetween, and is fixed to the protruding portion.

According to this aspect, the fan can be easily fixed to the shaft compared to a case where the fan is installed inside the rotary electric machine, inside the controller, or between the rotary electric machine and the controller.

In the above aspect, preferably, the electric drive device further comprises a duct cover (34) that covers outer circumferences of the rotary electric machine, the controller, and the fan, wherein the cooling air passage is formed between the duct cover and both of the housing and the casing.

According to this aspect, the cooling air introduced into the cooling air passage by the fan can flow smoothly along the outer circumferential surface of the housing and the outer circumferential surface of the casing.

In the above aspect, preferably, the shaft hole is arranged closer to the rotary electric machine than a central portion of the controller in the axial direction is to the rotary electric machine, and the vent is arranged on a side opposite to the rotary electric machine with the central portion of the controller in the axial direction interposed therebetween.

According to this aspect, by separating the position of the shaft hole in the axial direction from the position of the vent in the axial direction, the distance from the shaft hole to the vent (i.e., the air flow distance in the internal space of the casing) can be increased. This increases the time for heat exchange between the air flowing through the internal space of the casing and the components of the controller, thereby enhancing the cooling effect on the controller.

In the above aspect, preferably, the at least one shaft hole comprises a plurality of shaft holes provided at intervals in a circumferential direction of the shaft, and the at least one vent comprises a plurality of vents provided at intervals in a circumferential direction of the casing.

According to this aspect, the flow rate of the air taken from the internal space of the shaft into the internal space of the casing through the shaft holes and the flow rate of the air taken from the internal space of the casing into the cooling air passage through the vents can be increased. This can improve the cooling performance for the controller.

In the above aspect, preferably, the rotary electric machine further includes a lid (37) that closes an opening of the housing on a side opposite to the controller, and the lid is provided with an inlet (53) that penetrates therethrough in the axial direction, the rotary electric machine or the controller is provided with a separating member (89) that separates an internal space of the housing from the internal space of the casing, and the separating member is provided with a flow hole (217) that penetrates therethrough in the axial direction, and the cooling air passage is connected to the inlet via the internal space of the housing, the flow hole, the internal space of the casing, and the vent.

According to this aspect, the internal space of the housing is separated from the internal space of the casing by the separating member. Accordingly, the mutual thermal influence between the components of the rotary electric machine and the components of the controller can be suppressed. Further, the negative pressure generated at the vent causes the air outside the electric drive device to be taken into the cooling air passage through the inlet, the internal space of the housing, the flow hole, the internal space of the casing, and the vent. Accordingly, not only the heat generated in the internal space of the casing but also the heat generated in the internal space of the housing can be discharged through the cooling air passage. This can improve not only the cooling performance for the controller but also the cooling performance for the rotary electric machine.

In the above aspect, preferably, the rotary electric machine further includes a lid (37) that closes an opening of the housing on a side opposite to the controller, and the lid is provided with an inlet (53) that penetrates therethrough in the axial direction, and the cooling air passage is connected to the inlet via an internal space of the housing, the internal space of the casing, and the vent.

According to this aspect, the negative pressure generated at the vent causes the air outside the electric drive device to be taken into the cooling air passage through the inlet, the internal space of the housing, the internal space of the casing, and the vent. Accordingly, not only the heat generated in the internal space of the casing but also the heat generated in the internal space of the housing can be discharged through the cooling air passage. This can improve not only the cooling performance for the controller but also the cooling performance for the rotary electric machine.

In the above aspect, preferably, the electric drive device is provided in a mobile body (1), and the shaft extends along a propulsion direction of the mobile body.

According to this aspect, it is possible to prompt the wind generated by the propulsion of the mobile body to be introduced into the internal space of the shaft from the tip end of the shaft. Accordingly, the cooling effect on the controller can be enhanced.

Thus, according to the above aspects, it is possible to suppress the temperature imbalance within the controller by sufficiently cooling the inner circumferential portion of the controller.

### BRIEF DESCRIPTION OF THE DRAWING(S)

FIG. 1 is a perspective view of an aircraft according to an embodiment;

FIG. 2 is a partial cross-sectional view showing a propulsion unit according to the embodiment;

FIG. 3 is a perspective view showing a propulsion drive device according to the embodiment;

FIG. 4 is an exploded perspective view showing the propulsion drive device according to the embodiment;

FIG. 5 is a cross-sectional view showing the propulsion drive device according to the embodiment;

FIG. 6 is a front view showing a controller according to the embodiment;

FIG. 7 is a front view showing a smoothing capacitor and its circumference according to the embodiment;

FIG. 8 is a perspective view showing fixing structures of power modules according to the embodiment;

FIG. 9 is a circuit diagram showing a DC power supply and the propulsion drive device according to the embodiment;

FIG. 10 is a perspective cross-sectional view showing the smoothing capacitor and its circumference according to the embodiment;

FIG. 11 is a perspective view showing the smoothing capacitor according to the embodiment;

FIG. 12 is a perspective view showing a case opening and its circumference according to the embodiment;

FIG. 13 is a perspective view showing an electric connection structure of the controller according to the embodiment;

FIG. 14 is a cross-sectional view showing a propulsion drive device according to the first modification of the embodiment; and

FIG. 15 is a cross-sectional view showing a propulsion drive device according to the second modification of the embodiment.

### DETAILED DESCRIPTION OF THE INVENTION

### <The Aircraft 1>

In the following, an aircraft 1 (an example of a mobile body) according to an embodiment of the present invention will be described with reference to the drawings.

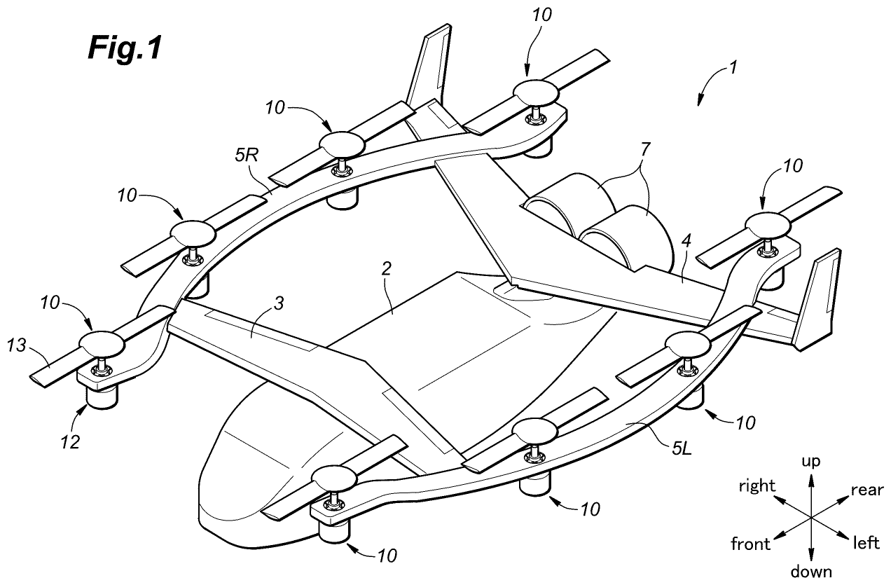

With reference to FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4.

A cabin (not shown) for an occupant to board is provided in the front portion of the body 2. Left and right propulsion units 7 (which will be described later) for applying the forward propulsion force to the aircraft 1 are provided at the rear end of the body 2. The propulsion units 7 may also be called “cruise units”.

The left arm 5L and the right arm 5R are each provided with a plurality of (for example, four) lift units 10 for applying the ascending and descending forces to the aircraft 1. The plurality of lift units 10 is arranged at intervals in the front-and-rear direction. The lift units 10 may also be called “vertical take-off and landing (VTOL) units”. Each lift unit 10 includes a lift drive device 12 and a lift rotor 13 attached to the lift drive device 12. The lift drive device 12 includes an electric motor (not shown), and is configured to rotate the lift rotor 13 by the driving force of the electric motor.

### <The Propulsion Unit 7>

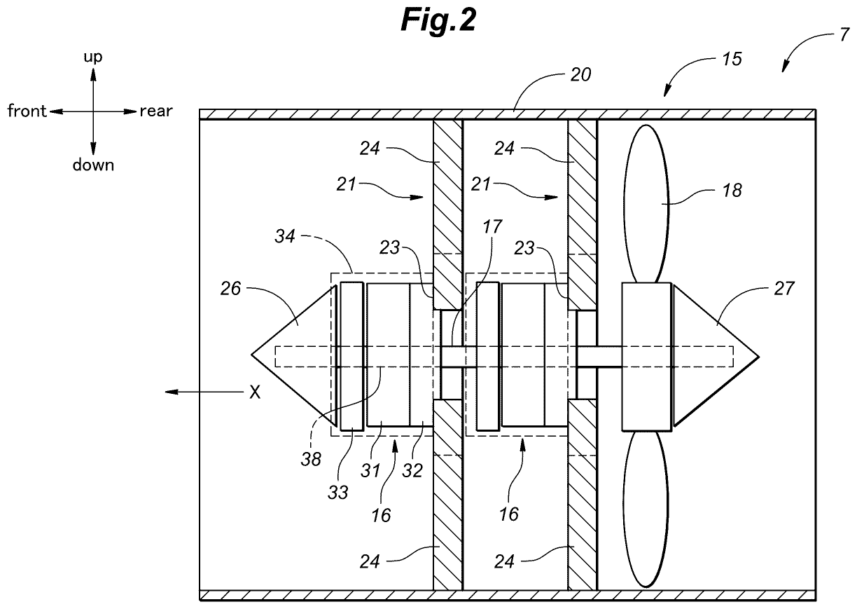

With reference to FIG. 2, each propulsion unit 7 includes a support body 15, front and rear propulsion drive devices 16 (an example of electric drive devices) supported by the support body 15, a rotation shaft 17 extending in the front-and-rear direction and rotatably supported by the front and rear propulsion drive devices 16, and a propulsion rotor 18 fixed to the rear portion of the rotation shaft 17.

The support body 15 is fixed to the rear end of the body 2 (see FIG. 1). The support body 15 includes a cylindrical nacelle 20 extending in the front-and-rear direction, and front and rear mount frames 21 fixed to the inner circumferential surface of the nacelle 20. Each mount frame 21 includes an annular hub 23 that is concentric with the nacelle 20, and a plurality of spokes 24 extending radially from the outer circumferential surface of the hub 23 and connected to the inner circumferential surface of the nacelle 20.

The front and rear propulsion drive devices 16 are accommodated in the nacelle 20. The front and rear propulsion drive devices 16 are fixed to the front surface of the hub 23 of the front and rear mount frames 21, respectively. The details of each propulsion drive device 16 will be described later.

The rotation shaft 17 is accommodated in the nacelle 20. The rotation shaft 17 penetrates through the hub 23 of each mount frame 21. A conical front cover 26 the diameter of which increases toward the rear is fixed to the front end of the rotation shaft 17. The front cover 26 is arranged in front of the front propulsion drive device 16. A conical rear cover 27 the diameter of which increases toward the front is fixed to the rear end of the rotation shaft 17. The rear cover 27 is arranged behind the central portion of the propulsion rotor 18.

The propulsion rotor 18 is accommodated in the nacelle 20. The propulsion rotor 18 is configured to rotate integrally with the rotation shaft 17 according to the rotation of the rotation shaft 17, thereby applying the forward propulsion force to the aircraft 1.

### <The Propulsion Drive Device 16>

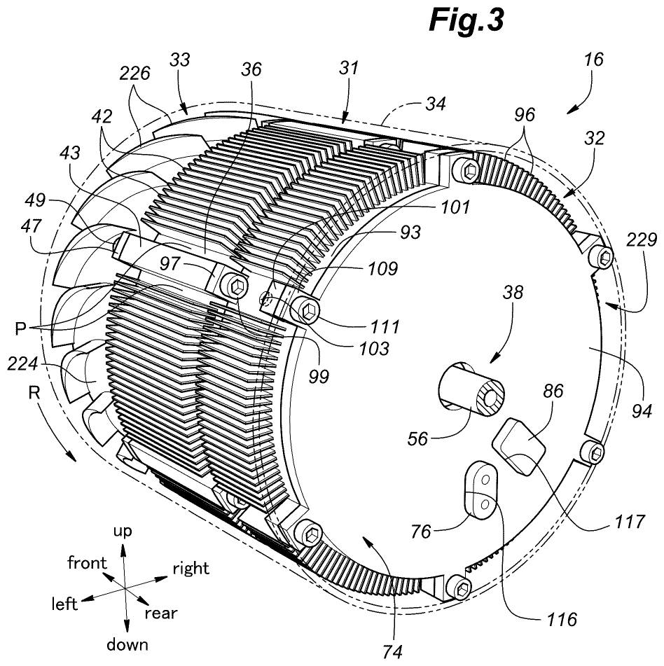

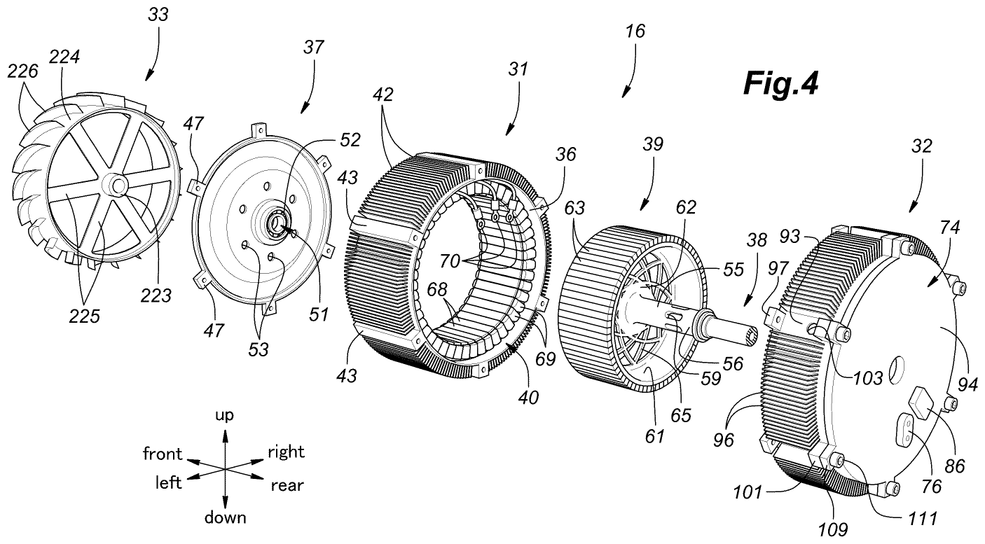

With reference to FIGS. 2 and 3, each propulsion drive device 16 includes an electric motor 31 (an example of a rotary electric machine), a controller 32 arranged on the rear side of the electric motor 31, a fan 33 arranged on the front side of the electric motor 31, and a duct cover 34 that covers the outer circumference of the electric motor 31, the controller 32, and the fan 33. In FIG. 4, the duct cover 34 is omitted.

### <The Electric Motor 31>

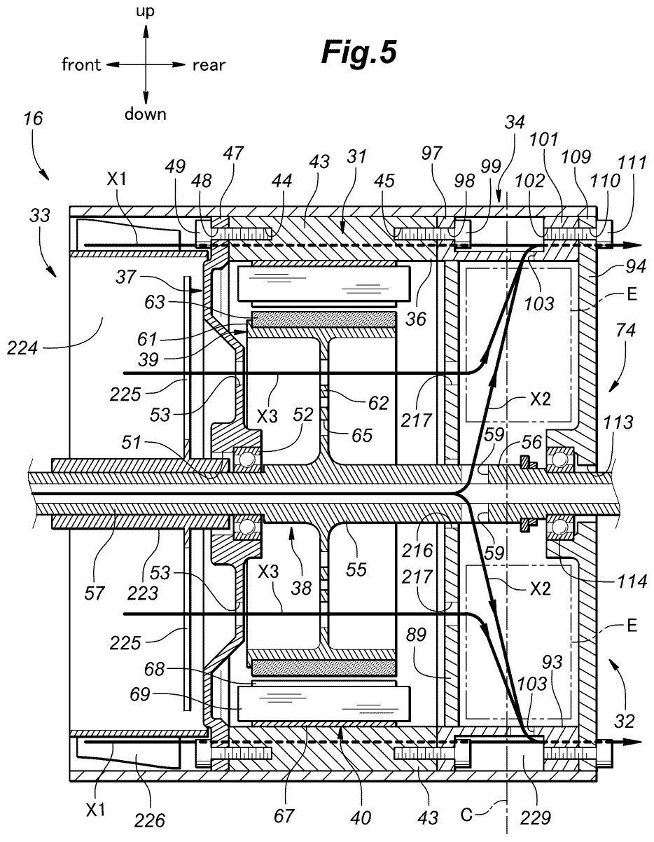

With reference to FIGS. 4 and 5, the electric motor 31 is sandwiched between the controller 32 and the fan 33. For example, the electric motor 31 is a three-phase AC motor of an inner rotor type. The electric motor 31 includes a housing 36, a lid 37, a shaft 38, a rotor 39, and a stator 40.

The housing 36 is cylindrical and extends in the front-and-rear direction on the outer circumference of the shaft 38. The housing 36 is arranged on the outer circumference of the rotor 39 and the stator 40 and accommodates the rotor 39 and the stator 40 (an example of structural components of the electric motor 31).

A plurality of first cooling fins 42 protrudes from the outer circumferential surface of the housing 36 at intervals in the circumferential direction of the housing 36. The plurality of first cooling fins 42 is formed integrally with the housing 36. Each first cooling fin 42 has a flat plate shape and extends along the front-and-rear direction. Each first cooling fin 42 extends continuously from the front end (one end in the front-and-rear direction) of the housing 36 to the rear end (the other end in the front-and-rear direction) thereof.

A plurality of fastening protrusions 43 protrudes from the outer circumferential surface of the housing 36 at intervals in the circumferential direction of the housing 36. The plurality of fastening protrusions 43 is provided between adjacent first cooling fins 42. Passages P of the cooling air that extend continuously from the front end of the housing 36 to the rear end thereof are formed between the adjacent first cooling fins 42 and each fastening protrusion 43. The plurality of fastening protrusions 43 is formed integrally with the housing 36.

Each fastening protrusion 43 is a rod-shaped portion with a rectangular cross-section and extends along the front-and-rear direction. That is, each fastening protrusion 43 extends parallel to each first cooling fin 42. Each fastening protrusion 43 extends continuously from the front end (one end in the front-and-rear direction) of the housing 36 to the rear end (the other end in the front-and-rear direction) thereof. Each fastening protrusion 43 is integrally formed of the same material from the front end (one end in the front-and-rear direction) of each fastening protrusion 43 to the rear end (the other end in the front-and-rear direction) thereof.

The front end of each fastening protrusion 43 is provided with a first bolt hole 44 for fastening the lid 37 to the housing 36. The rear end of each fastening protrusion 43 is provided with a second bolt hole 45 for fastening a casing 74 of the controller 32 (which will be described later) to the housing 36. The first bolt hole 44 and the second bolt hole 45 extend along the front-and-rear direction.

The lid 37 is adjacent to the housing 36 and closes the opening of the housing 36 on the front side (the side opposite to the controller 32). The lid 37 is a disk-shaped member and extends along a plane perpendicular to the front-and-rear direction. The lid 37 is formed separately from the housing 36. In another embodiment, the lid 37 may be formed integrally with the housing 36.

A plurality of first fastening pieces 47 protrudes from the outer circumferential portion of the lid 37 at intervals in the circumferential direction of the lid 37. Each first fastening piece 47 is provided with a first fastening hole 48 formed in the front-and-rear direction. The lid 37 is fastened to the housing 36 as a first fastening bolt 49 penetrating through the first fastening hole 48 engages with the first bolt hole 44 of each fastening protrusion 43 of the housing 36. A circular first through hole 51 is provided in the front-and-rear direction in the central portion of the lid 37. A first bearing 52 is attached to the first through hole 51. The inner circumferential portion (the portion between the outer circumferential portion and the central portion) of the lid 37 is provided with a plurality of inlets 53 that penetrates therethrough in the front-and-rear direction. The plurality of inlets 53 is provided at intervals in the circumferential direction of the lid 37.

With reference to FIG. 2, the shaft 38 extends in the front-and-rear direction (an example of the prescribed axial direction). The shaft 38 constitutes a portion of the rotation shaft 17 of the propulsion unit 7. Accordingly, as the shaft 38 rotates, the entire rotation shaft 17 rotates, and the propulsion rotor 18 rotates integrally with the rotation shaft 17. This applies the forward propulsion force to the aircraft 1, thereby propelling the aircraft 1 forward. The shaft 38 extends along the propulsion direction of the aircraft 1 (see an arrow X in FIG. 2).

With reference to FIG. 5, the shaft 38 is hollow. The shaft 38 includes a main body 55 accommodated in the housing 36, an extending portion 56 extending from the main body 55 toward the rear side (toward the controller 32), and a protruding portion 57 protruding from the main body 55 toward the front side (the side opposite to the controller 32). The extending portion 56 is provided with a plurality of shaft holes 59 that penetrates from an inner circumferential surface of the extending portion 56 to the outer circumferential surface thereof. The plurality of shaft holes 59 faces the internal space of the casing 74. The plurality of shaft holes 59 is provided at intervals in the circumferential direction of the shaft 38. The positions of the plurality of shaft holes 59 in the front-and-rear direction are identical to each other. In another embodiment, the positions of the plurality of shaft holes 59 in the front-and-rear direction may be offset from each other. The plurality of shaft holes 59 is arranged more forward (arranged closer to the electric motor 31) than the central portion C of the controller 32 in the front-and-rear direction. The protruding portion 57 penetrates through the first through hole 51 of the lid 37 and extends to the space on the front side of the electric motor 31. The protruding portion 57 is rotatably supported by the lid 37 via the first bearing 52.

With reference to FIGS. 4 and 5, the rotor 39 is hollow. The rotor 39 is arranged on the outer circumference of the main body 55 of the shaft 38. The rotor 39 includes a cylindrical rotor core 61 extending in the front-and-rear direction, a rotor plate 62 extending in the radial direction and connecting the main body 55 of the shaft 38 and the rotor core 61, and a plurality of permanent magnets 63 fixed to the outer circumferential surface of the rotor core 61. The rotor core 61 and the rotor plate 62 are formed integrally with the shaft 38. The rotor plate 62 is provided with a plurality of communication holes 65 penetrating therethrough in the front-and-rear direction.

The stator 40 is arranged on the outer circumference of the rotor 39 and faces the rotor 39 at a distance. The stator 40 includes a cylindrical stator core 67 extending in the front-and-rear direction, a plurality of teeth 68 protruding from the inner circumferential surface of the stator core 67, a plurality of coils 69 wound around the plurality of teeth 68, and three motor terminals 70 (an example of terminals of the rotary electric machine) connected to the plurality of coils 69. The stator core 67 is fixed to the inner circumferential surface of the housing 36. Among the components of the electric motor 31 and the controller 32, the plurality of coils 69 has the greatest heat generation. Accordingly, the heat generation of the electric motor 31 is greater than the heat generation of the controller 32. The three motor terminals 70 correspond to the U-phase, V-phase, and W-phase of the three-phase AC, respectively.

### <The Controller 32>

With reference to FIGS. 3 and 4, the controller 32 is integrated with the electric motor 31 and configured to control driving of the electric motor 31. In other words, the propulsion drive device 16 according to the present embodiment is a drive device in which the controller 32 is integrated with the electric motor 31.

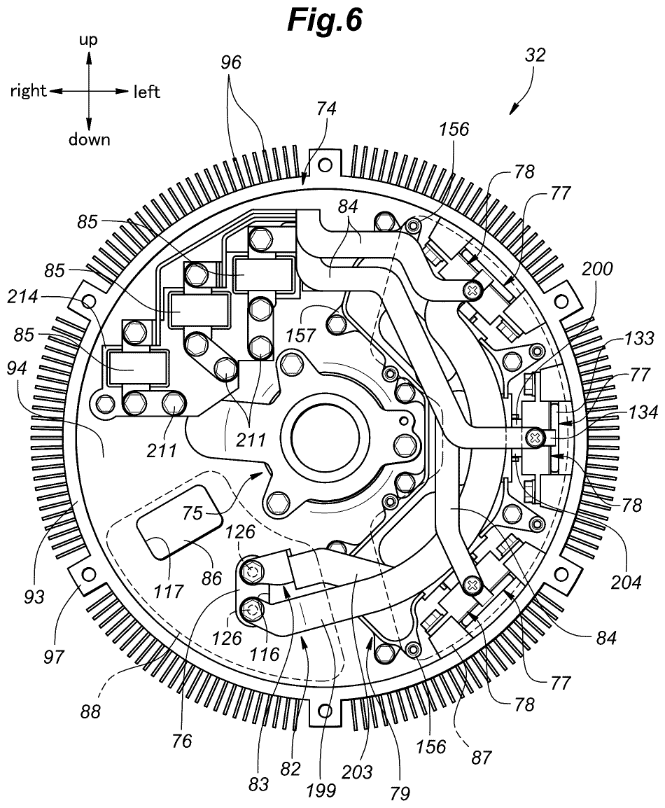

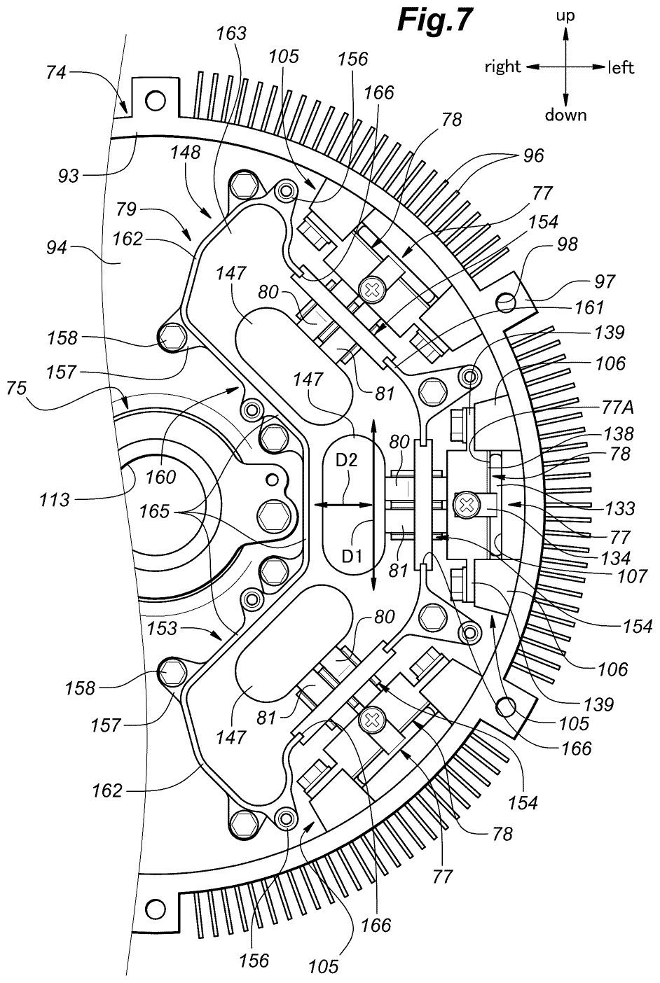

With reference to FIGS. 6 and 7, the controller 32 includes a casing 74, a resolver 75, a DC input connector 76, three power modules 77, three pressing members 78, a smoothing capacitor 79, three first connection members 80, three second connection members 81, first and second DC bus bars 82, 83, three AC bus bars 84, three electric current sensors 85, a communication connector 86, a drive board 87, a control board 88, and a separating member 89 (see FIG. 5). Further, in FIG. 5, electronic components E (for example, the three power modules 77, the smoothing capacitor 79, the three electric current sensors 85, the drive board 87, and the control board 88) of the controller 32 are omitted, and only the outline of the electronic components E is shown.

With reference to FIG. 5, the casing 74 is adjacent to the housing 36 of the electric motor 31. The casing 74 is made of metal and has a cylindrical shape with a bottom. The casing 74 accommodates the electronic components E of the controller 32.

The casing 74 includes a cylindrical circumferential wall 93 extending in the front-and-rear direction on the outer circumference of the extending portion 56 of the shaft 38, and a bottom wall 94 closing the opening of the circumferential wall 93 on the rear side (the side opposite to the electric motor 31). Hereinafter, the term “circumferential direction” used in the description of the components of the controller 32 will refer to the circumferential direction of the circumferential wall 93 of the casing 74 (in other words, the circumferential direction centered on the extending portion 56 of the shaft 38), and the term “radial direction” used in the description of the components of the controller 32 will refer to the radial direction of the circumferential wall 93 of the casing 74 (in other words, the radial direction centered on the extending portion 56 of the shaft 38).

With reference to FIGS. 3 and 4, a plurality of second cooling fins 96 protrudes from the outer circumferential surface of the circumferential wall 93 of the casing 74 at intervals in the circumferential direction. The plurality of second cooling fins 96 is formed integrally with the circumferential wall 93. Each second cooling fin 96 has a flat plate shape and extends along the front-and-rear direction. Each second cooling fin 96 extends continuously from the front end (one end in the front-and-rear direction) of the circumferential wall 93 to the rear end (the other end in the front-and-rear direction) thereof.

With reference to FIGS. 3 and 5, a plurality of second fastening pieces 97 protrudes at intervals in the circumferential direction from the front end (the end on the side of the electric motor 31) of the outer circumferential surface of the circumferential wall 93 of the casing 74. Each second fastening piece 97 is provided with a second fastening hole 98 formed in the front-and-rear direction. The casing 74 is fastened to the housing 36 as a second fastening bolt 99 penetrating through the second fastening hole 98 engages with the second bolt hole 45 of each fastening protrusion 43 of the housing 36.

A plurality of third fastening pieces 101 protrudes at intervals in the circumferential direction from the rear end (the end opposite to the electric motor 31) of the outer circumferential surface of the circumferential wall 93 of the casing 74. Each third fastening piece 101 is provided with a third fastening hole 102 formed in the front-and-rear direction.

The circumferential wall 93 of the casing 74 is provided with a plurality of vents 103 that penetrates from the inner circumferential surface of the circumferential wall 93 to the outer circumferential surface thereof. The plurality of vents 103 is provided at intervals in the circumferential direction. The positions of the plurality of vents 103 in the front-and-rear direction are identical to each other. In another embodiment, the positions of the plurality of vents 103 in the front-and-rear direction may be offset from each other. The plurality of vents 103 is arranged on the side opposite to the electric motor 31 with the central portion C of the controller 32 in the front-and-rear direction interposed therebetween. The position of each vent 103 in the circumferential direction matches the positions of each second fastening piece 97 and each third fastening piece 101 in the circumferential direction. Each vent 103 is provided between each second fastening piece 97 and each third fastening piece 101.

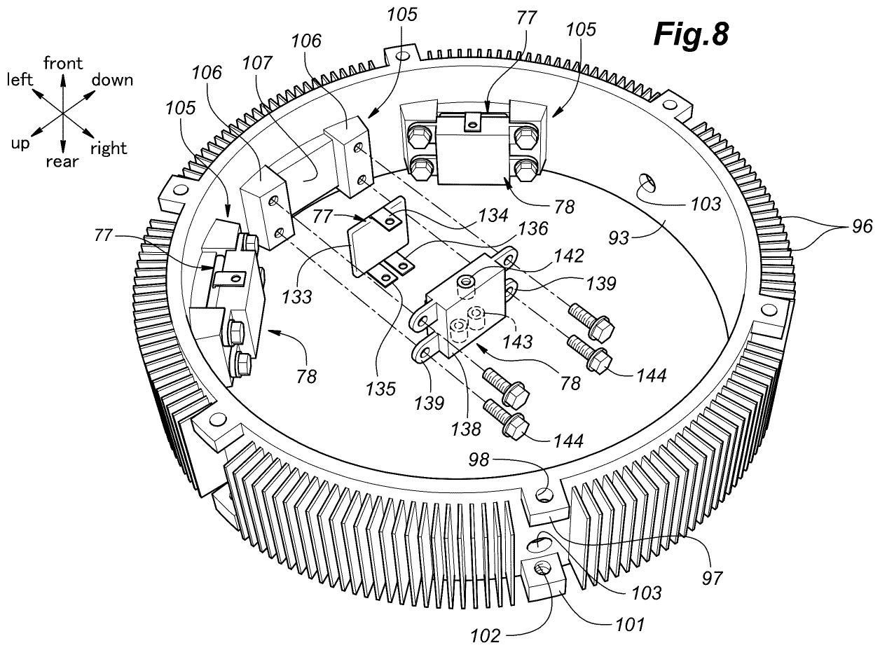

With reference to FIGS. 7 and 8, three pedestals 105 protrude from the inner circumferential surface of the circumferential wall 93 of the casing 74 at intervals in the circumferential direction. A pair of fixing protrusions 106 protrudes from both side portions in the circumferential direction of the inner surface (the inside surface in the radial direction) of each pedestal 105. An engagement recess 107 is provided between the pair of fixing protrusions 106 and in the central portion in the circumferential direction of the inner surface of each pedestal 105. Two of the three pedestals 105 are arranged such that the position of one of the fixing protrusions 106 in the circumferential direction overlaps with the position of one of the second fastening pieces 97 in the circumferential direction, and the other of the fixing protrusions 106 is arranged between the second fastening pieces 97 such that the position of the other of the fixing protrusions 106 in the circumferential direction does not overlap with the positions of the second fastening pieces 97 in the circumferential direction.

With reference to FIGS. 5 and 6, the bottom wall 94 of the casing 74 is a disk-shaped portion and extends along a plane perpendicular to the front-and-rear direction. The bottom wall 94 is formed separately from the circumferential wall 93. In another embodiment, the bottom wall 94 may be formed integrally with the circumferential wall 93.

A plurality of fourth fastening pieces 109 protrudes from the outer circumferential portion of the bottom wall 94 of the casing 74 at intervals in the circumferential direction. Each fourth fastening piece 109 is provided with a fourth fastening hole 110 formed in the front-and-rear direction. The bottom wall 94 is fastened to the circumferential wall 93 as a third fastening bolt 111 penetrating through the fourth fastening hole 110 engages with the third fastening hole 102 of each third fastening piece 101 of the circumferential wall 93.

A circular second through hole 113 is provided in the front-and-rear direction in the central portion of the bottom wall 94 of the casing 74. A second bearing 114 is attached to the second through hole 113. The extending portion 56 of the shaft 38 penetrates through the second through hole 113. The extending portion 56 of the shaft 38 is rotatably supported by the second through hole 113 via the second bearing 114. The lower portion of the bottom wall 94 is provided with a first fitting hole 116 and a second fitting hole 117 formed in the front-and-rear direction. The first fitting hole 116 and the second fitting hole 117 are provided at a distance from each other in the circumferential direction.

With reference to FIG. 6, the resolver 75 is fixed to the central portion of the bottom wall 94 of the casing 74. The resolver 75 includes a plurality of detection units (not shown) for detecting the rotation of the extending portion 56 of the shaft 38. The plurality of detection units are arranged at intervals in the circumferential direction.

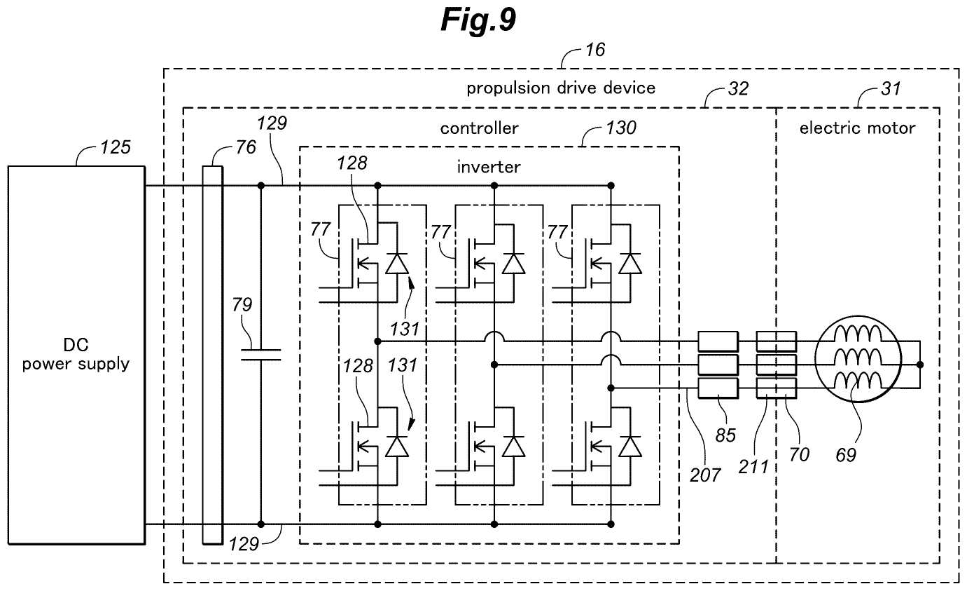

With reference to FIG. 9, the DC input connector 76 is connected to a DC power supply 125 provided outside the propulsion drive device 16. For example, the DC power supply 125 may be composed of a battery or a generator.

With reference to FIGS. 3 and 6, the DC input connector 76 fits into the first fitting hole 116 of the bottom wall 94 of the casing 74 and penetrates through the bottom wall 94 of the casing 74. A pair of DC input terminals 126 is provided on the front surface (the surface on the side of the electric motor 31) of the DC input connector 76.

With reference to FIG. 9, the three power modules 77 each include two switching elements 128. That is, the controller 32 includes a total of six switching elements 128. The six switching elements 128 are components of an inverter 130 (an example of a power conversion circuit) that converts DC power (direct current) input from the DC power supply 125 via a pair of DC lines 129 into AC power (alternating current). Each switching element 128 is composed of a semiconductor element such as an IGBT or a MOSFET. Each switching element 128 is arranged in parallel with a freewheel diode 131.

With reference to FIGS. 7 and 8, the three power modules 77 are arranged at intervals in the circumferential direction and contact with the inner circumferential surface of the circumferential wall 93 of the casing 74. The positions of the three power modules 77 in the circumferential direction do not overlap with the positions of the plurality of second fastening pieces 97 (i.e., the fastening points of the casing 74 and the housing 36) in the circumferential direction, but overlap with the positions of the plurality of second cooling fins 96 in the circumferential direction. The three power modules 77 are arranged to avoid the uppermost portion of the casing 74. An arrow D1 appropriately shown in each drawing indicates a direction (hereinafter referred to as “the first direction D1”) parallel to an inner surface 77A of each power module 77. An arrow D2 appropriately shown in each drawing indicates a direction (hereinafter referred to as “the second direction D2”) perpendicular to the first direction D1 and the inner surface 77A of each power module 77.

Each power module 77 includes a flat module body 133, an AC module bus bar 134 extending from the front end (one end in the front-and-rear direction) of the module body 133 toward the inside in the radial direction, and a first DC module bus bar 135 and a second DC module bus bar 136 extending from the rear end (the other end in the front-and-rear direction) of the module body 133 toward the inside in the radial direction.

The three pressing members 78 are arranged at intervals in the circumferential direction. Each pressing member 78 includes a rectangular parallelepiped engagement piece 138 and a plurality of protruding pieces 139 protruding from the engagement piece 138 toward both sides in the circumferential direction. The engagement piece 138 engages with the engagement recess 107 of each pedestal 105 arranged on the inner circumferential surface of the circumferential wall 93 of the casing 74. The engagement piece 138 and the engagement recess 107 of each pedestal 105 sandwich the module body 133 of each power module 77. The engagement piece 138 presses the module body 133 of each power module 77 against the engagement recess 107 of each pedestal 105. An AC insert nut 142 is embedded in the front surface (the surface on one side in the front-and-rear direction) of the engagement piece 138. Two DC insert nuts 143 are embedded in the rear surface (the surface on the other side in the front-and-rear direction) of the engagement piece 138. Each protruding piece 139 is fixed to each fixing protrusion 106 of each pedestal 105 by a fixing bolt 144.

With reference to FIG. 9, the smoothing capacitor 79 is connected to the DC power supply 125 in parallel with the inverter 130. The smoothing capacitor 79 smooths the direct current input to the inverter 130 from the DC power supply 125. More specifically, the smoothing capacitor 79 protects the three power modules 77 by smoothing a pulse electric current (a pulse-shaped electric current caused by a surge voltage) generated in the direct current input from the DC power supply 125 to the three power modules 77.

With reference to FIG. 7, the smoothing capacitor 79 is arranged at an interval from the inner circumferential surface of the circumferential wall 93 of the casing 74. The smoothing capacitor 79 and the three power modules 77 are arranged in the left semicircular portion (an example of one semicircular portion) of the casing 74. The smoothing capacitor 79 is continuously arranged along the inner surfaces 77A of the three power modules 77 (more specifically, the inner surfaces in the radial direction of the module bodies 133 of the three power modules 77). Accordingly, as viewed from the front side (the side of the electric motor 31), the smoothing capacitor 79 and each power module 77 are arranged in order from the inside in the radial direction to the outside in the radial direction between the second through hole 113 of the bottom wall 94 of the casing 74 and the inner circumferential surface of the circumferential wall 93 of the casing 74.

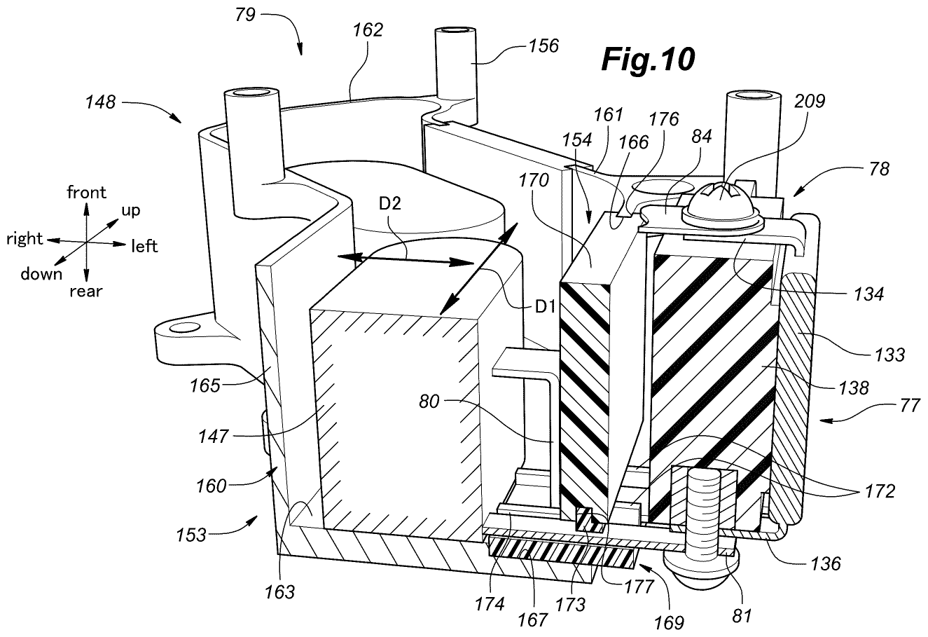

With reference to FIG. 10, the smoothing capacitor 79 is arranged at a distance in the radial direction from each power module 77. The smoothing capacitor 79 and each power module 77 are arranged on the same plane perpendicular to the front-and-rear direction. In other words, the position of the smoothing capacitor 79 in the front-and-rear direction overlaps with the position of each power module 77 in the front-and-rear direction.

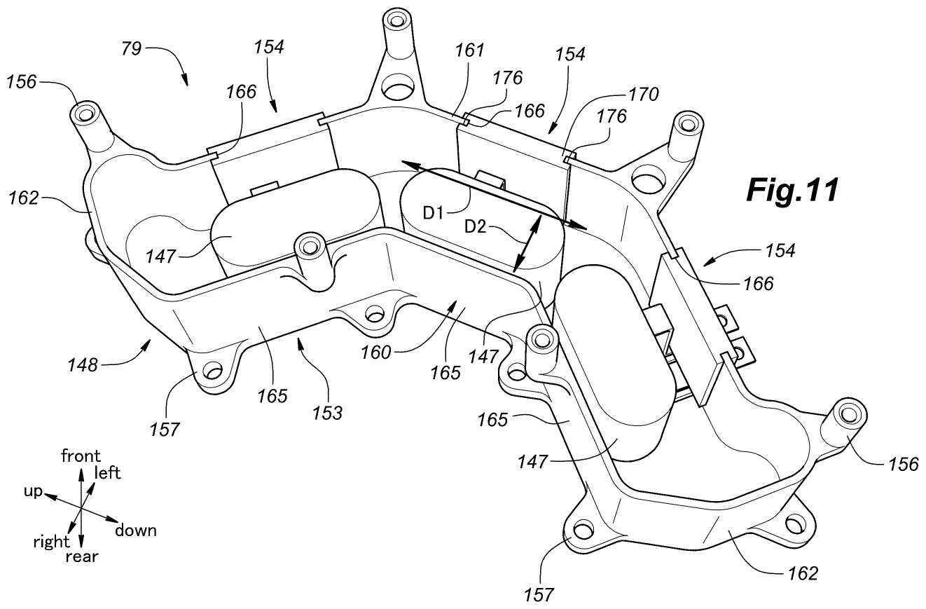

With reference to FIGS. 7 and 11, the smoothing capacitor 79 includes a plurality of capacitor elements 147 and a capacitor case 148 that accommodates the plurality of capacitor elements 147. That is, the smoothing capacitor 79 is configured as a capacitor unit that integrates the plurality of capacitor elements 147. As viewed from the front side (the side of the electric motor 31), the smoothing capacitor 79 is bent to protrude toward each power module 77 (toward the outside in the radial direction), and is a substantially U-shaped member.

The capacitor case 148 is filled with a potting material (not shown). For example, the potting material is made of an insulating resin. The capacitor case 148 includes a case body 153 and three closing members 154 attached to the case body 153.

The case body 153 of the capacitor case 148 is made of a metal such as aluminum. The case body 153 is a box-shaped member with the front surface (the surface on one side in the front-and-rear direction) opened. A plurality of support protrusions 156 is provided at the front end (one end in the front-and-rear direction) of the case body 153. A plurality of attachment protrusions 157 is provided at the rear end (the other end in the front-and-rear direction) of the case body 153. Each attachment protrusion 157 is attached to the bottom wall 94 of the casing 74 by an attachment bolt 158.

The case body 153 of the capacitor case 148 includes an inner wall 160 (a wall on the inside in the radial direction) extending in the circumferential direction, an outer wall 161 (a wall on the outside in the radial direction) extending in the circumferential direction on the outside in the radial direction of the inner wall 160, a pair of sidewalls 162 extending in the radial direction and connecting both ends of the inner wall 160 in the circumferential direction to both ends of the outer wall 161 in the circumferential direction, and a base wall 163 connecting the rear ends (the ends on the side opposite to the electric motor 31) of the inner wall 160, the outer wall 161, and the pair of sidewalls 162. The inner wall 160 has three flat surfaces 165 formed on the inside in the radial direction of the plurality of the capacitor elements 147. As viewed from the front side (the side of the electric motor 31), each flat surface 165 extends along the first direction D1. Three case openings 166 are formed in the outer wall 161 on the outside in the radial direction of the plurality of capacitor elements 147. The three case openings 166 are arranged at intervals in the circumferential direction. Each case opening 166 has a rectangular shape elongated in the front-and-rear direction and the first direction D1. Three fitting recesses 167 (see FIG. 10) are formed in the outside portion in the radial direction of the base wall 163 at positions facing the three case openings 166.

With reference to FIGS. 7 and 10, the three closing members 154 of the capacitor case 148 close the three case openings 166 of the case body 153, respectively. Each closing member 154 is made of an insulating resin. Each closing member 154 includes a first closing piece 169 and a second closing piece 170 that is arranged on the front side (one side in the front-and-rear direction) of the first closing piece 169.

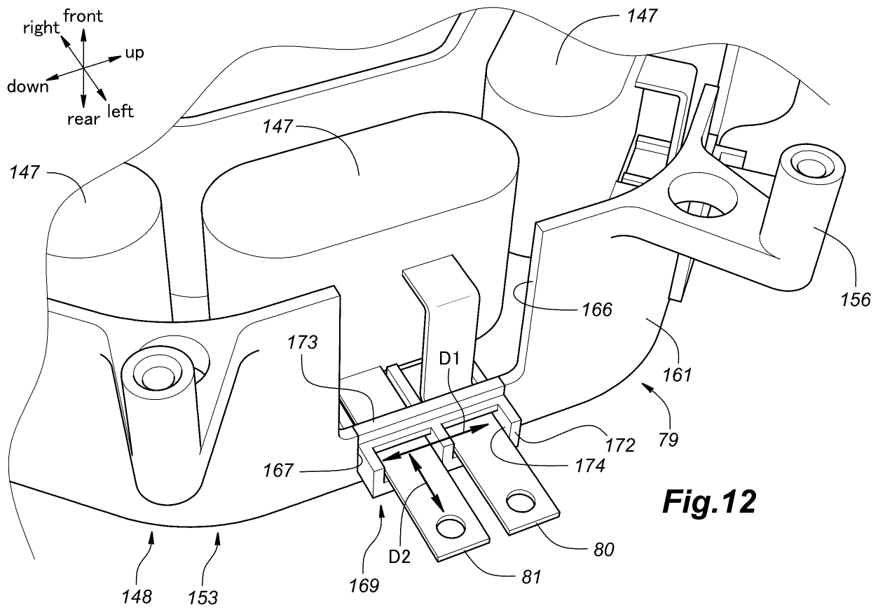

With reference to FIGS. 10 and 12, the first closing piece 169 of each closing member 154 fits into each fitting recess 167 of the case body 153. The front surface (the surface on one side in the front-and-rear direction) of the first closing piece 169 is provided with three partition ribs 172 extending in the second direction D2 and a connection rib 173 extending in the first direction D1 and connecting the middle portions of the three partition ribs 172. Two attachment grooves 174 extending in the second direction D2 are provided between the three partition ribs 172 and on the rear side (the other side in the front-and-rear direction) of the connection rib 173.

With reference to FIGS. 10 and 11, the second closing piece 170 of each closing member 154 is formed separately from the first closing piece 169. The second closing piece 170 has a flat rectangular parallelepiped shape elongated in the front-and-rear direction and the first direction D1. A pair of first engagement grooves 176 extending in the front-and-rear direction is formed in both side portions of the second closing piece 170 in the first direction D1. The pair of first engagement grooves 176 engages with the outer wall 161 of the case body 153 on both sides of each case opening 166 in the first direction D1. The front end (one end in the front-and-rear direction) of the second closing piece 170 is provided flush with the front surface (the surface on one side in the front-and-rear direction) of the outer wall 161 of the case body 153. A second engagement groove 177 extending in the first direction D1 is formed on the rear end (the other end in the front-and-rear direction) of the second closing piece 170. The second engagement groove 177 engages with the connection rib 173 of the first closing piece 169.

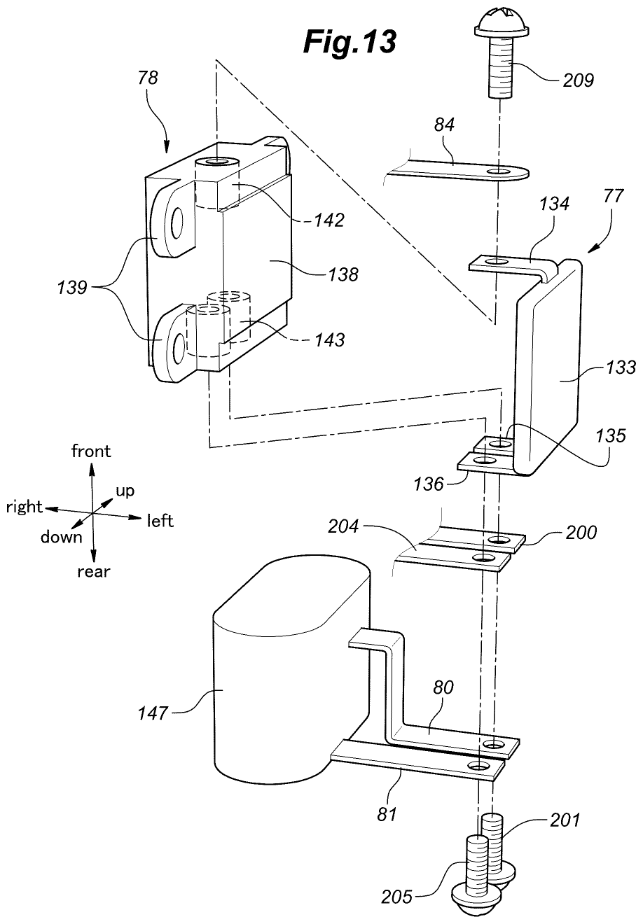

With reference to FIGS. 10 and 13, each first connection member 80 connects each capacitor element 147 to each power module 77. The end on the inside in the radial direction of each first connection member 80 is connected to the upper portion of the side surface (the surface on the outside in the radial direction) of each capacitor element 147. Each first connection member 80 engages with one attachment groove 174 of the first closing piece 169 of each closing member 154. Each first connection member 80 passes through the rear side of the second closing piece 170 (see FIGS. 10 and 11) of each closing member 154 and extends to the rear side of each power module 77. That is, each first connection member 80 penetrates through each closing member 154.

With reference to FIGS. 10 and 13, each second connection member 81 connects each capacitor element 147 to each power module 77. The end on the inside in the radial direction of each second connection member 81 is connected to the lower portion of the side surface (the surface on the outside in the radial direction) of each capacitor element 147. Each second connection member 81 engages with the other attachment groove 174 of the first closing piece 169 of each closing member 154. Each second connection member 81 passes through the rear side of the second closing piece 170 (see FIGS. 10 and 11) of each closing member 154 and extends to the rear side of each power module 77. That is, each second connection member 81 penetrates through each closing member 154.

With reference to FIG. 6, the first DC bus bar 82 includes a first main bus bar 199 extending in the circumferential direction, and three first auxiliary bus bars 200 bent from the outer circumferential portion of the first main bus bar 199 toward the rear side. One end of the first main bus bar 199 in the circumferential direction is connected to one DC input terminal 126 of the DC input connector 76. With reference to FIG. 13, the tip end of each first auxiliary bus bar 200 is bent toward the outside in the radial direction and extends to the rear side of each pressing member 78. The tip end of each first auxiliary bus bar 200, the first DC module bus bar 135 of each power module 77, and the end on the outside in the radial direction of each first connection member 80 are fixed to one DC insert nut 143 of each pressing member 78 by a first fixing bolt 201. Accordingly, the first DC bus bar 82, each power module 77, and each first connection member 80 are connected to each other.

With reference to FIG. 6, the second DC bus bar 83 includes a second main bus bar 203 extending in the circumferential direction, and three second auxiliary bus bars 204 bent from the outer circumferential portion of the second main bus bar 203 toward the rear side. One end of the second main bus bar 203 in the circumferential direction is connected to the other DC input terminal 126 of the DC input connector 76. With reference to FIG. 13, the tip end of each second auxiliary bus bar 204 is bent toward the outside in the radial direction and extends to the rear side of each pressing member 78. The tip end of each second auxiliary bus bar 204, the second DC module bus bar 136 of each power module 77, and the end on the outside in the radial direction of each second connection member 81 are fixed to the other DC insert nut 143 of each pressing member 78 by a second fixing bolt 205. Accordingly, the second DC bus bar 83, each power module 77, and each second connection member 81 are connected to each other.

With reference to FIGS. 6 and 13, one end in the longitudinal direction of each AC bus bar 84 and the AC module bus bar 134 of each power module 77 are fixed to the AC insert nut 142 of each pressing member 78 by a third fixing bolt 209. Accordingly, each AC bus bar 84 and each power module 77 are connected to each other. An AC output terminal 211 is provided at the other end in the longitudinal direction of each AC bus bar 84. That is, the controller 32 is provided with three AC output terminals 211. The three AC output terminals 211 and the pair of DC input terminals 126 are arranged in the right semicircular portion (an example of the other semicircular portion) of the casing 74. The three AC output terminals 211 are arranged at an interval in the circumferential direction from the pair of DC input terminals 126. The AC output terminals 211 are connected to the motor terminals 70 (see FIG. 4) of the stator 40 of the electric motor 31 in the internal space of the casing 74. Accordingly, as shown in FIG. 9, the alternating current output from the inverter 130 (three power modules 77) is output to each coil 69 of the electric motor 31 via each AC output terminal 211 and each motor terminal 70.

With reference to FIG. 9, the three electric current sensors 85 are arranged on three AC lines 207 (three-phase lines), respectively. The three AC lines 207 extend from the inverter 130 (three power modules 77) to each coil 69 of the electric motor 31. The three electric current sensors 85 detect the values of the electric currents output from the three power modules 77.

With reference to FIG. 6, the three electric current sensors 85 are arranged on the three AC bus bars 84, respectively. The three electric current sensors 85 are arranged in the right semicircular portion of the casing 74. The three electric current sensors 85 are arranged at intervals in the circumferential direction. The three electric current sensors 85 are fixed to a sensor holder 214 fixed to the outer circumferential portion of the bottom wall 94 of the casing 74. The sensor holder 214 is formed separately from the resolver 75.

The communication connector 86 is arranged between the pair of DC input terminals 126 and the three AC output terminals 211 in the circumferential direction. The communication connector 86 fits into the second fitting hole 117 of the bottom wall 94 of the casing 74 and penetrates through the bottom wall 94 of the casing 74. The communication connector 86 is connected to an external device (for example, a controller of the body 2) provided outside the propulsion drive device 16.

The drive board 87 is a gate drive board for driving the switching elements 128 (semiconductor elements) of the three power modules 77. The drive board 87 is arranged on the front side (the side of the electric motor 31) of the smoothing capacitor 79. The drive board 87 is supported by the plurality of support protrusions 156 provided in the case body 153 of the capacitor case 148 of the smoothing capacitor 79.

The control board 88 is an ECU board that controls driving of the inverter 130 (three power modules 77) via the drive board 87. The control board 88 is connected to the drive board 87 via a connector (not shown), and is also connected to the communication connector 86 via a cable (not shown). The control board 88 is held by a holding member (not shown) attached to the bottom wall 94 of the casing 74.

With reference to FIG. 5, the separating member 89 separates the internal space of the housing 36 from the internal space of the casing 74. The separating member 89 separates the rotor 39 and the stator 40 of the electric motor 31 from the electronic components E (for example, the three power modules 77, the smoothing capacitor 79, the three electric current sensors 85, the drive board 87, and the control board 88) of the controller 32. The separating member 89 is accommodated in the casing 74. In another embodiment, the separating member 89 may be accommodated in the housing 36 of the electric motor 31. The separating member 89 has a flat plate shape along a plane perpendicular to the front-and-rear direction. An axial hole 216 is formed in the central portion of the separating member 89. The extending portion 56 of the shaft 38 penetrates through the axial hole 216. The separating member 89 is provided with a plurality of flow holes 217 that penetrates therethrough in the front-and-rear direction. The plurality of flow holes 217 is arranged closer to the outside in the radial direction than the axial hole 216. The plurality of flow holes 217 is provided at intervals in the circumferential direction.

### <The Fan 33>

With reference to FIGS. 3 to 5, the fan 33 is arranged on the front side (one side in the front-and-rear direction) of the electric motor 31. The fan 33 is arranged on the side opposite to the controller 32 with the electric motor 31 interposed therebetween. The fan 33 includes a cylindrical hub 223 extending in the front-and-rear direction, a cylindrical rim 224 extending in the front-and-rear direction on the outer circumference of the hub 223, and a plurality of spokes 225 extending in the radial direction and connecting the hub 223 and the rim 224. The hub 223 is fixed to the protruding portion 57 of the shaft 38 of the electric motor 31. Accordingly, the fan 33 is configured to rotate integrally with the shaft 38. A plurality of air blowing ribs 226 is provided on the outer circumferential surface of the rim 224 at intervals in the circumferential direction of the rim 224. Each air blowing rib 226 inclines forward (to one side in the front-and-rear direction) toward the downstream side in the rotational direction R of the fan 33.

### <The Duct Cover 34>

With reference to FIGS. 3 and 5, the duct cover 34 has a cylindrical shape extending in the front-and-rear direction. A cooling air passage 229 is formed between the duct cover 34 and both the housing 36 of the electric motor 31 and the circumferential wall 93 of the casing 74 of the controller 32. That is, the cooling air passage 229 is formed on the outer circumference of the housing 36 of the electric motor 31 and the casing 74 of the controller 32. The cooling air passage 229 is cylindrical and extends in the front-and-rear direction. The plurality of vents 103 of the casing 74 faces the cooling air passage 229. Accordingly, the cooling air passage 229 is connected to the internal space of the shaft 38 via the plurality of shaft holes 59 of the extending portion 56 of the shaft 38, the internal space of the casing 74, and the plurality of vents 103 of the casing 74. Further, the cooling air passage 229 is connected to the plurality of inlets 53 of the lid 37 via the internal space of the housing 36, the plurality of flow holes 217 of the separating member 89, the internal space of the casing 74, and the plurality of vents 103 of the casing 74.

### <Cooling of the Electric Motor 31 and the Controller 32>

With reference to FIGS. 3 and 5, when the electric motor 31 is driven and the shaft 38 rotates, the fan 33 fixed to the protruding portion 57 of the shaft 38 rotates integrally with the shaft 38. Accordingly, as shown by an arrow X1 in FIG. 5, the cooling air is blown by the plurality of air blowing ribs 226 of the fan 33 toward the outer circumferential surface of the housing 36 and the outer circumferential surface of the circumferential wall 93 of the casing 74. That is, the cooling air is introduced into the cooling air passage 229 by the plurality of air blowing ribs 226 of the fan 33.

The cooling air introduced into the cooling air passage 229 flows on the outer circumference of the housing 36 and between the plurality of first cooling fins 42 from the front side to the rear side. Accordingly, the electric motor 31 is cooled by the cooling air. Next, the cooling air flows on the outer circumference of the circumferential wall 93 of the casing 74 and between the plurality of second cooling fins 96 from the front side to the rear side. Accordingly, the casing 74 of the controller 32 is cooled by the cooling air. The cooling air that has passed through the outer circumference of the circumferential wall 93 of the casing 74 is discharged from the rear end of the cooling air passage 229 to the space behind the controller 32.

When the cooling air passes through the cooling air passage 229 as described above, the negative pressure is generated at the plurality of vents 103 of the casing 74. More specifically, the pressure at the plurality of vents 103 of the casing 74 becomes negative relative to the pressure in the internal space of the shaft 38 and the pressure in the internal space of the casing 74. Accordingly, as shown by an arrow X2 in FIG. 5, the outside air introduced from the front end of the hollow shaft 38 into the internal space of the shaft 38 is taken into the cooling air passage 229 via the plurality of shaft holes 59 of the extending portion 56 of the shaft 38, the internal space of the casing 74, and the plurality of vents 103 of the casing 74. The air taken into the cooling air passage 229, together with the cooling air flowing through the cooling air passage 229, is discharged from the rear end of the cooling air passage 229 to the space behind the controller 32.

Further, when the negative pressure is generated at the plurality of vents 103 of the casing 74 as described above, as shown by an arrow X3 in FIG. 5, the outside air is taken into the cooling air passage 229 via the plurality of inlets 53 of the lid 37, the internal space of the housing 36, the plurality of flow holes 217 of the separating member 89, the internal space of the casing 74, and the plurality of vents 103 of the casing 74. The air taken into the cooling air passage 229, together with the cooling air flowing through the cooling air passage 229, is discharged from the rear end of the cooling air passage 229 to the space behind the controller 32.

To efficiently introduce the wind generated by the propulsion of the aircraft 1 from the front end of the shaft 38, the front cover 26 (see FIG. 2) arranged in front of the propulsion drive device 16 may be provided with a through hole (not shown) for exposing the front end of the shaft 38. Further, a filter structure may be provided at the front end of the shaft 38 to prevent a foreign object (for example, moisture or dust) other than air from entering the internal space of the shaft 38.

### <Effects>

In the present embodiment, in a drive device in which the controller 32 is integrated with the electric motor 31, the controller 32 is cooled using the plurality of second cooling fins 96 provided on the outer circumferential surface of the circumferential wall 93 of the casing 74. When such a configuration is adopted, the temperature of the outer circumferential portion of the internal space of the casing 74 that is close to the plurality of second cooling fins 96 is likely to be lowered, but the temperature of the inner circumferential portion of the internal space of the casing 74 that is far from the plurality of second cooling fins 96 is unlikely to be lowered. Accordingly, it is difficult to uniformly lower the ambient temperature in the internal space of the casing 74.

Considering this, in the present embodiment, the negative pressure generated at the plurality of vents 103 is utilized to introduce the air in the internal space of the shaft 38 into the cooling air passage 229 via the plurality of shaft holes 59 of the extending portion 56 of the shaft 38, the internal space of the casing 74, and the plurality of vents 103 of the casing 74. Accordingly, the air in the internal space of the shaft 38 passes through the inner circumferential portion and the outer circumferential portion of the internal space of the casing 74 and flows into the cooling air passage 229. Accordingly, the inner circumferential portion and the outer circumferential portion of the controller 32 can be effectively cooled.

In particular, the air in the internal space of the shaft 38 is first introduced into the inner circumferential portion of the internal space of the casing 74. Accordingly, the inner circumferential portion of the controller 32 where the heat is prone to be trapped can be sufficiently cooled, and the temperature imbalance within the controller 32 can be suppressed. Accordingly, the inner circumferential portion and the outer circumferential portion of the controller 32 have the same level of cooling performance, which makes it easier to evaluate the cooling performance of the controller 32.

Further, since the inner circumferential portion of the controller 32 can be sufficiently cooled as described above, the thermal influence on the electronic components E arranged in the inner circumferential portion of the controller 32 can be suppressed. Accordingly, it is not necessary to use highly heat-resistant devices as the electronic components E to be arranged in the inner circumferential portion of the controller 32 in consideration of the thermal influence described above, which makes it easier to select the electronic components E to be arranged in the inner circumferential portion of the controller 32.

### <Modifications>

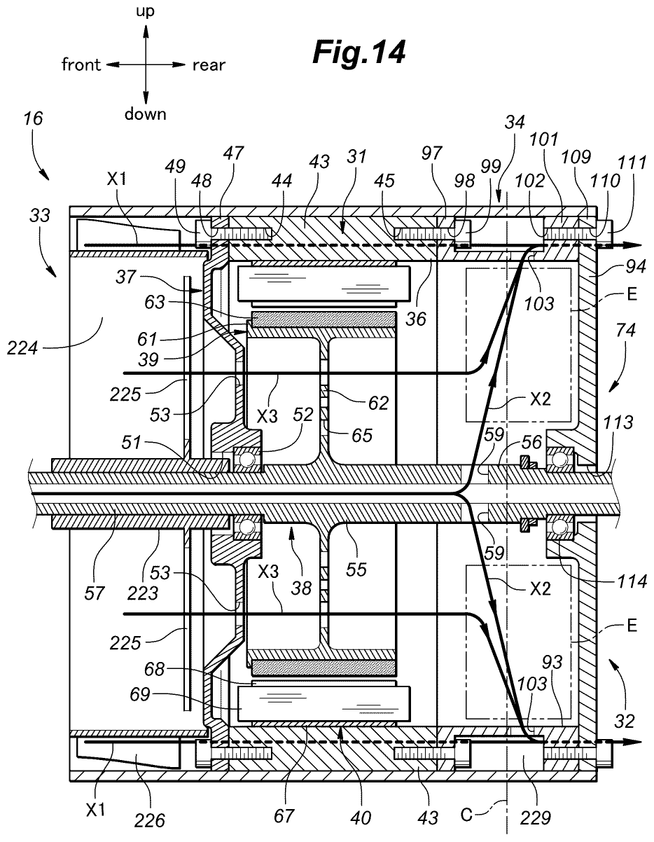

In the above embodiment, the internal space of the housing 36 is separated from the internal space of the casing 74 by the separating member 89. As shown in FIG. 14, in the first modification of the above embodiment, the separating member 89 is not provided, and the internal space of the housing 36 and the internal space of the casing 74 entirely communicate with each other. Accordingly, the cooling air passage 229 is connected to the plurality of inlets 53 of the lid 37 via the internal space of the housing 36, the internal space of the casing 74, and the plurality of vents 103 of the casing 74.

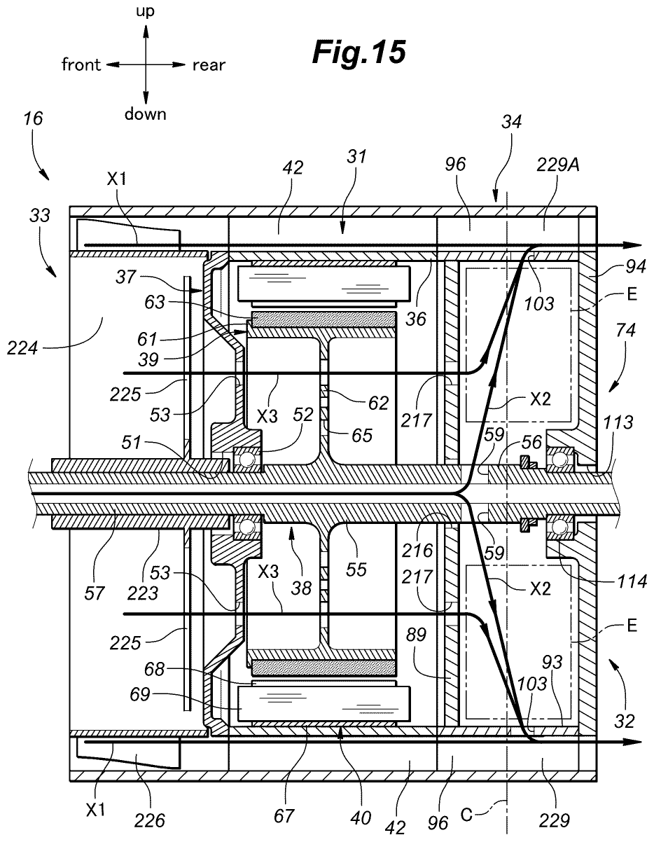

In the above embodiment, the position of each vent 103 in the circumferential direction matches the positions of each second fastening piece 97 and each third fastening piece 101 in the circumferential direction. As shown in FIG. 15, in the second modification of the above embodiment, the position of each vent 103 in the circumferential direction is offset from the positions of each second fastening piece 97 and each third fastening piece 101 in the circumferential direction. In this case, axial direction passages 229A provided continuously from the front end (one end) of the circumferential wall 93 of the casing 74 to the rear end (the other end) thereof along the front-and-rear direction may be formed between the plurality of second cooling fins 96 in the cooling air passage 229, and each vent 103 may be arranged to face one of the axial direction passages 229A.

In the above embodiment, the propulsion drive device 16 includes the fan 33. In another embodiment, the propulsion drive device 16 may not include the fan 33. In this case, the front cover 26 (see FIG. 2) arranged in front of the propulsion drive device 16 may be omitted so that the wind generated by the propulsion of the aircraft 1 may be directly introduced into the cooling air passage 229.

In the above embodiment, the electric motor 31 of an inner rotor type is an example of a rotary electric machine. In another embodiment, an electric motor of an outer rotor type may be an example of the rotary electric machine, or a generator may be an example of the rotary electric machine.

In the above embodiment, the configuration of the present invention is applied to the propulsion drive device 16. In another embodiment, the configuration of the present invention may be applied to the lift drive device 12.

In the above embodiment, the configuration of the present invention is applied to an electric vertical take-off and landing aircraft. In another embodiment, the configuration of the present invention may be applied to an aircraft other than an electric vertical take-off and landing aircraft (i.e., a general aircraft that cannot take off and land vertically), or the configuration of the present invention may be applied to a mobile body other than an aircraft (for example, a vehicle such as an automobile or a motorcycle). Further, in another embodiment, the configuration of the present invention may be applied to a device that is fixedly installed.

This concludes the description of the specific embodiments, but the present invention is not limited to the above embodiments or modifications, and can be widely modified and implemented.

1. An electric drive device, comprising:
a rotary electric machine; and
a controller integrated with the rotary electric machine and configured to control driving of the rotary electric machine,
wherein the rotary electric machine includes:
a hollow shaft extending in a prescribed axial direction; and
a housing extending in the axial direction on an outer circumference of the shaft,
the shaft includes:
a main body accommodated in the housing; and
an extending portion extending from the main body toward the controller,
the extending portion is provided with at least one shaft hole that penetrates from an inner circumferential surface of the extending portion to an outer circumferential surface thereof,
the controller includes a casing extending in the axial direction on an outer circumference of the extending portion, and the casing is provided with at least one vent that penetrates from an inner circumferential surface of the casing to an outer circumferential surface thereof, and
a cooling air passage extending in the axial direction is formed on an outer circumference of the casing such that the vent faces the cooling air passage, and the cooling air passage is connected to an internal space of the shaft via the shaft hole, an internal space of the casing, and the vent.

2. The electric drive device according to claim 1, further comprising a fan configured to rotate integrally with the shaft and thereby introduce cooling air into the cooling air passage.

3. The electric drive device according to claim 2, wherein the shaft further includes a protruding portion protruding from the main body toward a side opposite to the controller, and
the fan is arranged on the side opposite to the controller with the rotary electric machine interposed therebetween, and is fixed to the protruding portion.

4. The electric drive device according to claim 2, further comprising a duct cover that covers outer circumferences of the rotary electric machine, the controller, and the fan,
wherein the cooling air passage is formed between the duct cover and both of the housing and the casing.

5. The electric drive device according to claim 1, wherein the shaft hole is arranged closer to the rotary electric machine than a central portion of the controller in the axial direction is to the rotary electric machine, and
the vent is arranged on a side opposite to the rotary electric machine with the central portion of the controller in the axial direction interposed therebetween.

6. The electric drive device according to claim 1, wherein the at least one shaft hole comprises a plurality of shaft holes provided at intervals in a circumferential direction of the shaft, and
the at least one vent comprises a plurality of vents provided at intervals in a circumferential direction of the casing.

7. The electric drive device according to claim 1, wherein the rotary electric machine further includes a lid that closes an opening of the housing on a side opposite to the controller, and the lid is provided with an inlet that penetrates therethrough in the axial direction,
the rotary electric machine or the controller is provided with a separating member that separates an internal space of the housing from the internal space of the casing, and the separating member is provided with a flow hole that penetrates therethrough in the axial direction, and
the cooling air passage is connected to the inlet via the internal space of the housing, the flow hole, the internal space of the casing, and the vent.

8. The electric drive device according to claim 1, wherein the rotary electric machine further includes a lid that closes an opening of the housing on a side opposite to the controller, and the lid is provided with an inlet that penetrates therethrough in the axial direction, and
the cooling air passage is connected to the inlet via an internal space of the housing, the internal space of the casing, and the vent.

9. The electric drive device according to claim 1, wherein the electric drive device is provided in a mobile body, and the shaft extends along a propulsion direction of the mobile body.
